(19) United States
(12) Patent Application Publication
(10) Pub. No.: US 2004/0090460 A1
(43) Pub. Date: May 13, 2004

(54) Method and apparatus for updating a User Interface for a computer system based on a physics model

(76) Inventor: Hideya Kawahara, Mountain View, CA (US)

Correspondence Address: PARK, VAUGHAN & FLEMING LLP, 508 SECOND STREET, SUITE 201, DAVIS, CA, 95616, US

(21) Appl. No.: 10/292,851

(22) Filed: Nov. 12, 2002

(51) Int. Cl. G09G 5/00

(52) U.S. Cl. 345/764; 345/781

(57) ABSTRACT

One embodiment of the present invention provides a system for updating a User Interface (UI) for a computer system. During operation, the system receives a request from a user or an application to modify a spatial attribute of a widget in the UI, such as the size or the location of the widget, wherein the term “widget” generally refers to any UI component, including windows, frames, buttons, list boxes, etc. In response to this request, the system modifies the spatial attribute of the widget. In modifying the spatial attribute of the widget, the system ensures that the modifications adhere to a physics model.

### BACKGROUND

1. Field of the Invention

The present invention relates to User Interfaces (Uls) for computer systems. More specifically, the present invention relates to a method and an apparatus for updating a UI for a computer system based on a physics model.

2. Related Art

Devices that use a display for user interaction, such as personal computers and information kiosks, typically provide a User Interface (UI) framework that includes a windowing system. These windowing systems contain UI components referred to as “widgets” through which users can interact with applications running on the device. The term “widget” generally refers to any UI component, including windows, frames, buttons, list boxes, etc. User interfaces for applications are developed by combining these widgets.

Users and applications are typically allowed to change the spatial attributes of a widget, such as the size of the widget or the widget's location. For example, a user can specify such a change through a pointing device, such as a mouse. Similarly, an application can specify such a change by making function calls to the windowing system. In most cases, these changes take place instantaneously, although in some newer Uls, animation sequences accompany these changes.

Humans typically respond more favorably to environments that mimic reality. While instantaneous changes to the spatial attributes of widgets do not pose any problems, they prevent the user from feeling the virtual world presented by the windowing system in a natural manner. The closer a windowing system comes to presenting a virtual world that mimics reality, the more comfortable users typically feel when interacting with the windowing system. Many video games use this concept to present a more complete gaming experience; however, video gaming environments cannot serve as a UI framework for computer applications.

What is needed is a method and an apparatus for updating a UI for a computer system in a manner that more closely mimics reality.

### SUMMARY

One embodiment of the present invention provides a system for updating a User Interface (UI) for a computer system. During operation, the system receives a request from a user or an application to modify a spatial attribute of a widget in the UI, such as the size or the location of the widget. In response to this request, the system modifies the spatial attribute of the widget. In modifying the spatial attribute of the widget, the system ensures that the modifications adhere to a physics model.

In a variation on this embodiment, the system modifies the widget by modifying the location of one or more anchor points in the UI that the widget is coupled to.

In a further variation on this embodiment, upon modifying the location of the anchor point, the system uses the physics model to calculate the sum of all of the forces acting on the widget with the new anchor point. Once a net force has been determined, the system moves the widget in the direction of the net force. The system continues to calculate the net force as the location of the widget changes in response to the net force.

In a variation on this embodiment, the widget is connected to an anchor point in the UI via an idealized spring defined within the physics model.

In a further variation on this embodiment, the physics model defines a spring constant and a natural length for the spring.

In a variation on this embodiment, the physics model defines a gravitational force, wherein the gravitational force pulls objects in the UI towards the bottom of the UI.

In a variation on this embodiment, the physics model defines a wind force, wherein the wind force pushes objects in the UI in accordance with a model for the wind force.

In a variation on this embodiment, the physics model defines a frictional force, wherein the frictional force counteracts the movement of objects in the UI.

In a variation on this embodiment, each object in the UI has a mass, wherein the mass is used in determining the magnitude of the effects of the different forces on the object.

### BRIEF DESCRIPTION OF THE FIGURES

FIG. 1 illustrates a windowing system for a computer system in accordance with an embodiment of the present invention.

FIG. 2 illustrates a windowing system containing a physics model in accordance with an embodiment of the present invention.

FIG. 3 illustrates a window object in accordance with an embodiment of the present invention.

FIG. 4 presents a flowchart illustrating the process of altering physical attributes of a window in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Windowing System

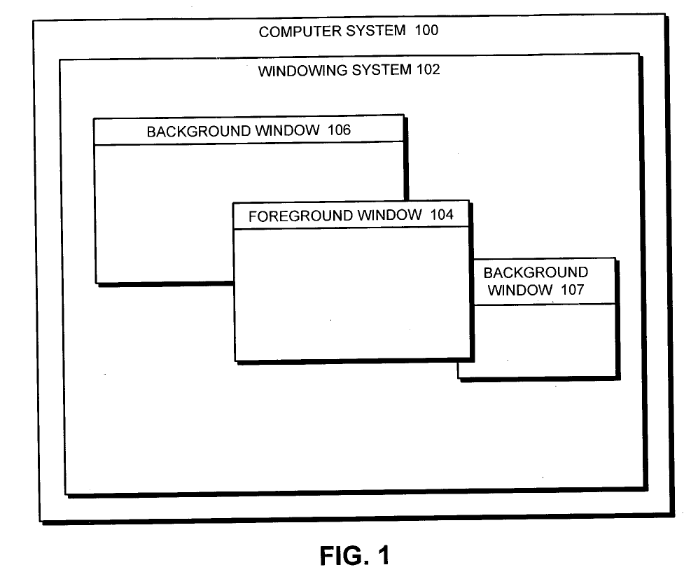

FIG. 1 illustrates windowing system 102 for computer system 100 in accordance with an embodiment of the present invention. Computer system 100, which contains windowing system 102, can generally include any type of computer system, including, but not limited to, a computer system based on a microprocessor, a mainframe computer, a digital signal processor, a portable computing device, a personal organizer, a device controller, and a computational engine within an appliance.

In general, windowing system 102 can include any Graphical User Interface (GUI) running on computer system 100. In the example illustrated in FIG. 1, windowing system 102 contains objects such as foreground window 108 and background windows 106 and 107. Note that windowing system 102 can generally contain any number of objects, and the number of objects that windowing system 102 contains can vary over time.

Windowing System Employing a Physics Model

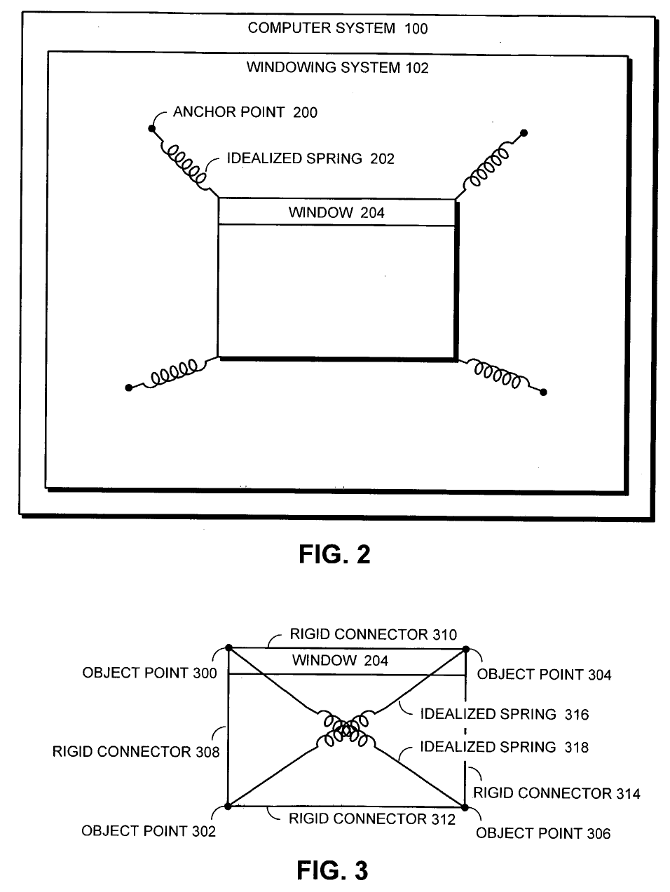

FIG. 2 illustrates windowing system 102 that operates in accordance with a physics model in accordance with an embodiment of the present invention. Windowing system 102 has the following characteristics:

Properties of objects that windowing system 102 controls are defined by a physics model, which specifies the behavior of the objects. Attributes such as an object's size can play an important role in determining behavior of the object. For example, size can be used to determine the mass of an object, which can be used in calculating the motion of the object.

The physics model describes relationships among groups of objects. For example, in one embodiment of the present invention, the physics model defines a repulsive force between unrelated objects and idealized springs between related objects belonging to a similar group. These exemplary relationships act to keep the objects that are related closer together, and to keep unrelated objects apart.

The physics model can define the potential energy of an object based on the location of an object. Depending on the type of application running, it could be desirable to have objects located towards the top of the screen to have a higher potential energy state than objects that are located towards the bottom of the screen.

The physics model can define how a user interacts with the objects. For example, mouse motion can be interpreted as a force being applied to the object, wherein the direction of the force is equivalent to the direction of the mouse movement and magnitude of the force is proportional to the speed with which the mouse is moved.

Calculation for the physics model can be an iterative process. Every movement of an object in windowing system 102 changes the environment and the forces on the other objects. Windowing system 102 must constantly recalculate the forces on all of the objects as the objects move and perform the appropriate actions.

The physics model can include forces in three dimensions, but must be able to represent the virtual world in two dimensions for two-dimensional display devices.

The physics model can include “wind” and “gravity.” These forces can help to identify specific objects. For instance, an object that has focus, such as foreground window 104, can remain in a fixed location while unrelated windows that do not have focus, such as background windows 106 and 107, can move slowly in the background like leaves blowing in a gently breeze or floating on the surface of an almost still pond. Applying the physics model in this manner can help to achieve a natural motion.

The physics model can include a frictional force that counteracts the movement of objects.

In the example shown in FIG. 2, window 204 is held in place in windowing system 102 by a set of idealized springs, such as idealized spring 202. Note that these idealized springs are not actually visible to the user of windowing system 102. They are merely used to model the motion of window 204 within windowing system 102. One end of idealized spring 202 is attached to window 204, while the other end is attached to anchor point 200. Anchor point 200 represents a fixed point in windowing system 102. In this manner, window 204 can exhibit limited movement based on forces being applied by the physics model, but cannot move very far from the anchor points because of counteracting forces generated by the idealized springs. Note that the physics model must also define a spring constant and a natural length for idealized spring 202.

Window Object

FIG. 3 illustrates a window object in accordance with an embodiment of the present invention. Objects within windowing system 102 can also include a collection of smaller objects. For instance, window 204 can be modeled as a collection of object points, such as object points 300, 302, 304, and 306; rigid connectors, such as rigid connectors 308, 310, 312, and 314; and idealized springs, such as idealized springs 316 and 318. In this example, object points 300, 302, 304, and 306 all have a mass associated with them, as well as a location and a velocity, and forces act on object points 300, 302, 304, and 306 independently of each other. The object points are held together by rigid connectors. For example, object point 300 is bound to object point 302 by rigid connector 308. Idealized springs 316 and 318 are connected diagonally across window 204 to keep window 204 in a rectangular shape.

Process of Altering Physical Attributes of a Window

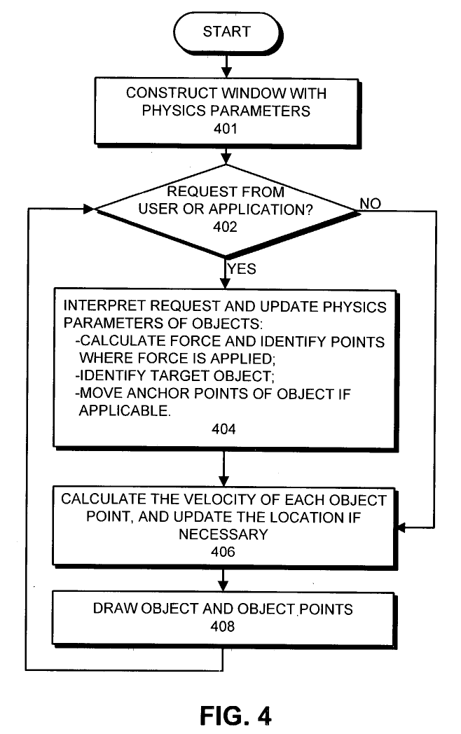

FIG. 4 presents a flowchart illustrating the process of altering physical attributes of a window in accordance with a physics simulation. This physics simulation is an iterative process that runs the entire time that windowing system 102 is operating. Every time an object is modified or moved in windowing system 102, it affects the forces acting on other objects. Therefore, windowing system 102 constantly applies the physics model to this ever-changing environment.

The system starts be constructing a window, such as window 204, with specific physics parameters (step 401). These physics parameters can include: the length of the rigid connectors; the number, length, and mass of the object points, as well as their location and velocity; the location and number of anchor points; and the number, spring constants, and natural lengths of idealized springs. The system also creates a data structure within windowing system 102 that represents window 204. The current values of all of the physics parameters are stored within this data structure.

Next, windowing system 102 determines if there is a request from either an application or a user (step 402). An application can generate a request by making a function call to windowing system 102, whereas a user can generate a request by providing input through a number of mechanisms, the most common of which is a mouse or other pointing device. If, there is no request, the system proceeds to step 406.

Otherwise, if there is request, the system interprets the request and updates the physics parameters accordingly (step 404). This can be accomplished, for example, by calculating a force specified by the request and identifying the object points on which the force is applied. Note that the actions specified by the request may not be limited to one object, but may affect a collection of objects. Hence, the system first identifies the target object or objects. If necessary, the system modifies the location of anchor points of these target objects.

Once a force associated with request has been determined, the system calculates the velocity of each object point and updates its location as necessary (step 406). Calculating the sum of all of the forces on an object point allows the system to determine changes in the object point's velocity. These forces can include forces arising from wind, gravity, friction, attraction between objects, repulsion between objects, collisions between objects, springs, or usersupplied forces to name a few. Once the sum of all of the forces has been calculated for the object point, if the sum is greater than zero, the object point is accelerated in the direction of the sum of all the forces. This can be represented as follows:

v1=v0+(Σ(f)/m)*d

l1=l0+v1*d

where, v1 is the new velocity, v0 is the old velocity, Σ(f) is the sum of all the forces that act on the target point, d is a time factor constant, l1 is the new location, and l0 is the old location. Finally, the system draws the object and the object points in their current location (step 408).

This process for applying the physics model is constantly repeated for all of the objects within windowing system 102 while windowing system 102 is active.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for updating a User Interface (UI) for a computer system, comprising:
receiving a request to modify a spatial attribute of a widget in the UI, wherein the spatial attribute can include the size or the location of the widget; and
modifying the widget in accordance with the request;
wherein modifying the widget involves ensuring that modifications to the spatial attribute of the widget adhere to a physics model.

2. The method of claim 1, wherein modifying the widget involves modifying the location of an anchor point in the UI that the widget is coupled to.

3. The method of claim 2, wherein modifying the location of the anchor point further comprises:
using the physics model to calculate a sum of all of the forces acting on the widget with the new anchor point; and
moving the widget toward a location where the sum of all of the forces acting on the widget is equal to zero.

4. The method of claim 1, wherein the widget is coupled to an anchor point in the UI via an idealized spring defined within the physics model.

5. The method of claim 4, wherein the physics model defines a spring constant and a natural length for the spring.

6. The method of claim 1, wherein the physics model defines a gravitational force, wherein the gravitational force pulls objects in the UI towards the bottom of the UI.

7. The method of claim 1, wherein the physics model defines a wind force, wherein the wind force pushes objects in the UI in accordance with a model for the wind force.

8. The method of claim 1, wherein the physics model defines a frictional force, wherein the frictional force counteracts the movement of objects in the UI.

9. The method of claim 1, wherein each object in the UI has a mass value, wherein the mass value is used in determining a magnitude of the effects of the different forces on the object.

10. A computer-readable storage medium storing instructions that when executed by a computer cause the computer to perform a method for updating a User Interface (UI) for a computer system, the method comprising:
receiving a request to modify a spatial attribute of a widget in the UI, wherein the spatial attribute can include the size or the location of the widget; and
modifying the widget in accordance with the request;
wherein modifying the widget involves ensuring that modifications to the spatial attribute of the widget adhere to a physics model.

11. The computer-readable storage medium of claim 10, wherein modifying the widget involves modifying the location of an anchor point in the UI that the widget is coupled to.

12. The computer-readable storage medium of claim 11, wherein modifying the location of the anchor point further comprises:
using the physics model to calculate a sum of all of the forces acting on the widget with the new anchor point; and
moving the widget toward a location where the sum of all of the forces acting on the widget is equal to zero.

13. The computer-readable storage medium of claim 10, wherein the widget is coupled to an anchor point in the UI via an idealized spring defined within the physics model.

14. The computer-readable storage medium of claim 13, wherein the physics model defines a spring constant and a natural length for the spring.

15. The computer-readable storage medium of claim 10, wherein the physics model defines a gravitational force, wherein the gravitational force pulls objects in the UI towards the bottom of the UI.

16. The computer-readable storage medium of claim 10, wherein the physics model defines a wind force, wherein the wind force pushes objects in the UI in accordance with a model for the wind force.

17. The computer-readable storage medium of claim 10, wherein the physics model defines a frictional force, wherein the frictional force counteracts the movement of objects in the UI.

18. The computer-readable storage medium of claim 10, wherein each object in the UI has a mass value, wherein the mass value is used in determining a magnitude of the effects of the different forces on the object.

19. An apparatus for updating a User Interface (UI) for a computer system, comprising:
a receiving mechanism configured to receive a request to modify a spatial attribute of a widget in the UI, wherein the spatial attribute can include the size or the location of the widget; and
a modification mechanism configured to modify the widget in accordance with the request;
wherein modifying the widget involves ensuring that modifications to the spatial attribute of the widget adhere to a physics model.

20. The apparatus of claim 19, wherein the modification mechanism is further configured to modify the location of an anchor point in the UI that the widget is coupled to.

21. The apparatus of claim 20, further comprising:
a calculation mechanism configured to use the physics model to calculate a sum of all of the forces acting on the widget with the new anchor point; and
a relocation mechanism configured to move the widget toward a location where the sum of all of the forces acting on the widget is equal to zero.

22. The apparatus of claim 19, wherein the widget is coupled to an anchor point in the UI via an idealized spring defined within the physics model.

23. The apparatus of claim 22, wherein the physics model defines a spring constant and a natural length for the spring.

24. The apparatus of claim 19, wherein the physics model defines a gravitational force, wherein the gravitational force pulls objects in the UI towards the bottom of the UI.

25. The apparatus of claim 19, wherein the physics model defines a wind force, wherein the wind force pushes objects in the UI in accordance with a model for the wind force.

26. The apparatus of claim 19, wherein the physics model defines a frictional force, wherein the frictional force counteracts the movement of objects in the UI.

27. The apparatus of claim 19, wherein each object in the UI has a mass value, wherein the mass value is used in determining a magnitude of the effects of the different forces on the object.

28. A means for updating a User Interface (UI) for a computer system, comprising:
a receiving means for receiving a request to modify a spatial attribute of a widget in the UI, wherein the spatial attribute can include the size or the location of the widget; and
a modification means for modifying the widget in accordance with the request;
wherein modifying the widget involves ensuring that modifications to the spatial attribute of the widget adhere to a physics model.

29. An operating system containing instructions that when executed by a computer cause the computer to perform a method for updating a User Interface (UI) for a computer system, the method comprising:
receiving a request to modify a spatial attribute of a widget in the UI, wherein the spatial attribute can include the size or the location of the widget; and
modifying the widget in accordance with the request;
wherein modifying the widget involves ensuring that modifications to the spatial attribute of the widget adhere to a physics model.
